(19) United States
(12) Patent Application Publication
(10) Pub. No.: US 2006/0065199 A1
(43) Pub. Date: Mar. 30, 2006

(54) Gravity filled animal feeder with a method and means for collapsing while simultaneously closing the feed container and for expanding while simultaneously opening and dispensing animal feed

(76) Inventor: Waldon Edman Davis, Chester, AR (US)

Correspondence Address: WALDON E. DAVIS, 7501 CHESTER CUTOFF, CHESTER, AR, 72934, US

(21) Appl. No.: 10/947,942

(22) Filed: Sep. 24, 2004

(51) Int. Cl. A01K 39/00

(52) U.S. Cl. 119/51.01

(57) ABSTRACT

The gravity filling feeder is a vertically positioned pipe shaped material including a feed reservoir and a feeding bowl at the bottom. The feeder is adjustable in size with many size options to choose from. Inside the feeder, a piece of cone shaped material acts as a funnel and regulates the amount of feed being supplied to the feeding bowl. A cap is placed on top of the feeder to protect the feeder from the weather. The feeder has brackets with straps attached to them for the purpose of attachment to a tree or a post.

### BACKGROUND—FIELD OF INVENTION

The present invention relates to a collapsible animal feeder with a storage cavity and a means of filling the dispensing area by way of gravity.

Animal feeders are common and come in a myriad of forms and display a wide variety of delivery methods. The present invention combines a means of collapsing for ease of carrying or transporting, along with a means of closing the feed containment area so that there is no spillage while carrying or transporting the device. The device also provides a convenient means of installing the device on a tree, or any vertical or overhead support structure. The feed is dispensed by means of gravity in a manner that is self regulating and allows the feed dispenser to remain constantly filled, without overfilling, until all the stored feed is gone. Although the present invention is depicted in cylindrical form it may be constructed with any cross section shape so long as the container segments nest inside one another.

### BACKGROUND—DESCRIPTION OF PRIOR ART

The prior art includes several devices that dispense feed to animals. All of the prior designs have distinct disadvantages and none of them disclose the novel design of the present invention.

Examples of prior art devices include:
(a) U.S. Pat. No. 5,819,687 relates to a gravity filled wildlife feeder that is designed to look like a tree stump. It does not have a means of collapsing and simultaneously closing the container or transporting the feeder without spilling the feed unless you were to first remove feed before transport.

(b) U.S. patent application Ser. No. 2,972,334 relates to a gravity dispensed wildlife feeder. It does not have a means of collapsing and simultaneously closing the container or transporting without spillage.

(c) U.S. Pat. No. 5,333,572 Relates to a wildlife feeder that is hung from a wire or tree branch that dispenses feed by means of a motorized dispenser. It does not have a means of collapsing and simultaneously closing the container or transporting without spillage.

There continues to be a need for a new and improved device for dispensing feed to animals that is convenient to transport.

### OBJECTS AND ADVANTAGES

Several objectives and advantages of the present patent are:
(a) to provide a means creating a compact animal feed dispensing device that is convenient to transport
(b) to provide a means of simultaneously closing and collapsing a container and/or feed dispenser for ease of carrying or transporting.
(c) to provide a gravity filled dispenser that is self regulating
(d) to provide a means of installing an animal feeder to a tree trunk or other support structure that is convenient and secure
(e) to provide a means to transport a feeder with food still in container without spillage.
(f) to provide a means for creating a feeder that will allow for proper drainage if water enters the container

### DRAWING FIGURES

In the drawings:

FIG. 1 Shows a perspective view of the present invention

FIG. 2 Shows a perspective view of the present invention with hidden lines in gray to show internal components

FIG. 3 Displays an exploded view of the present invention

FIG. 4 Shows a section view of the present invention with a detailed view of the area of interaction between feed and baffle

FIG. 5 Shows a side and perspective view of the present invention installed on a structure

FIG. 6 Shows a perspective view of the present invention in the open position, a perspective view of the present invention in the closed position as well as a side and cutaway view of the present invention in the closed position

FIG. 7 Shows a section view of the present invention with details showing the restricting device and holes or vents for allowing water to escape or drain.

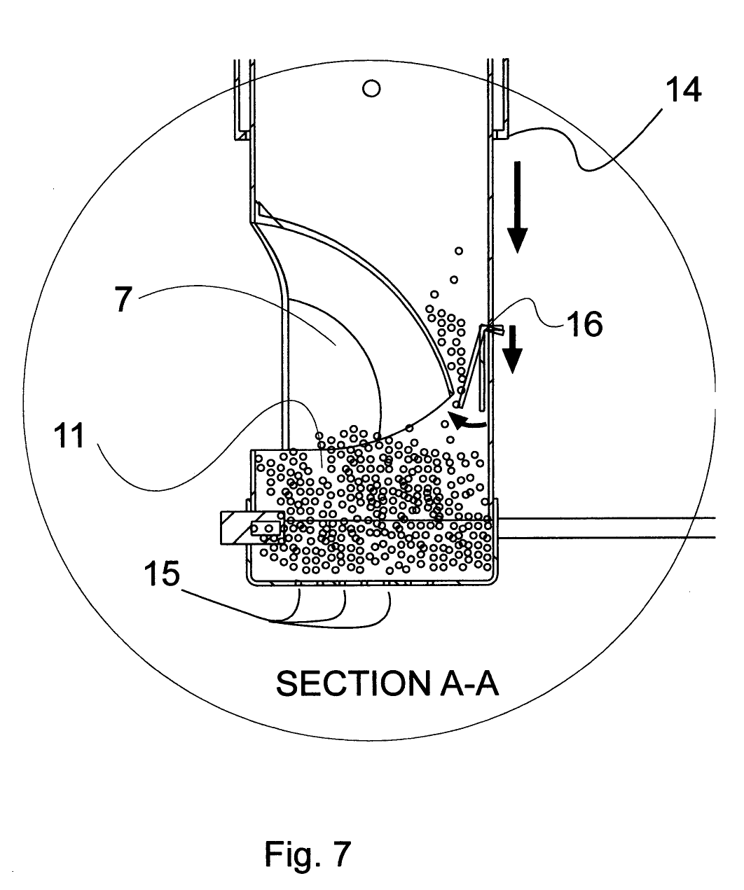

FIG. 8 Shows a cutaway perspective view of the present invention in a closed position

### REFERENCE NUMERALS IN DRAWING

1 Outer container segment
2 Inner container segment
3 Cap
4 Strap system
5 Strap fastening device
6 Bracket
7 Baffle
8 Adjustable strap
9 Hole in lower container
10 Bracket inside of lower container
11 Animal feed
12 Tree or other structure
13 Area of one container segment covering the hole in the corresponding container segment
14 Lip or form providing interference to keep container segments from accidentally separating
15 Holes or vents for allowing water to escape
16 Restricting device
17 Holes, detents or other means for holding container segments apart
18 Pin, locking device or other means of interference to lock container segments in position

### DESCRIPTION OF THE INVENTION

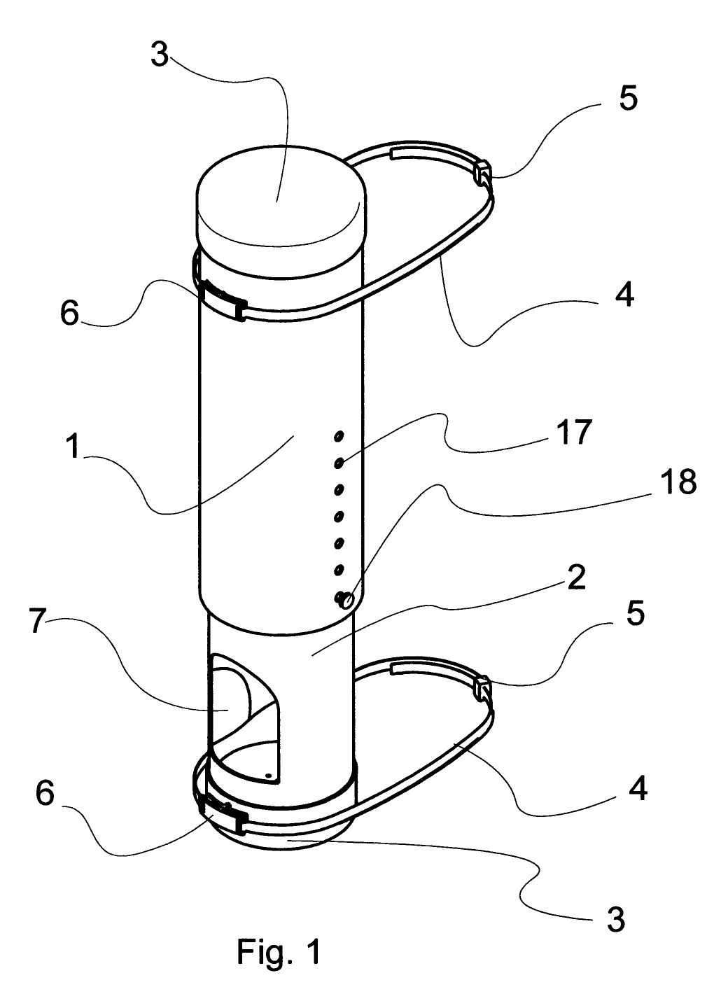

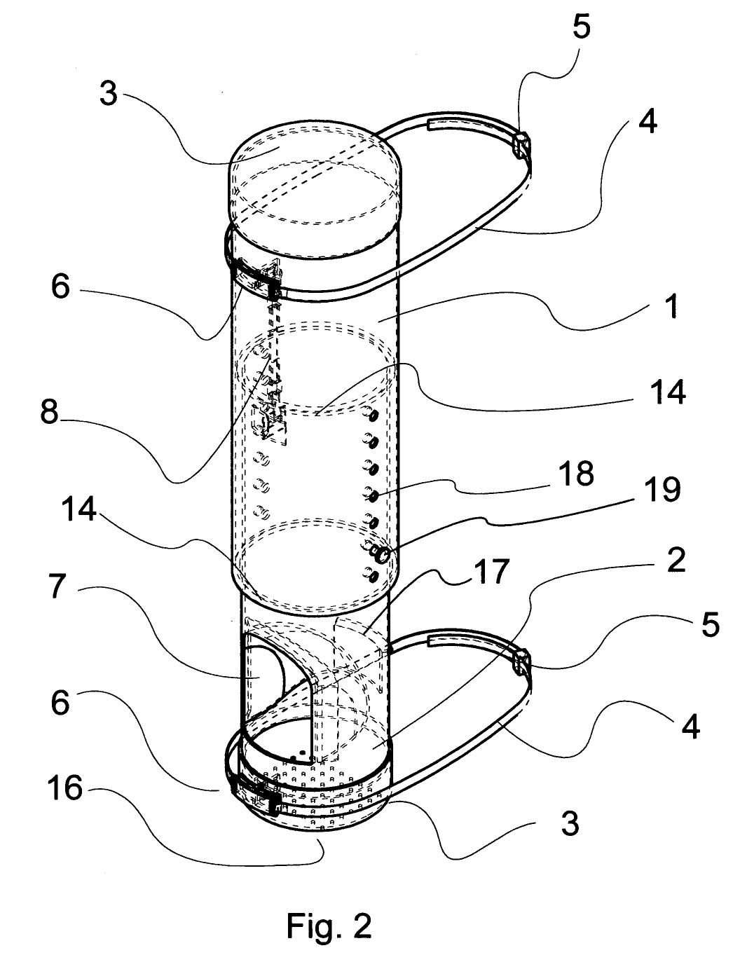

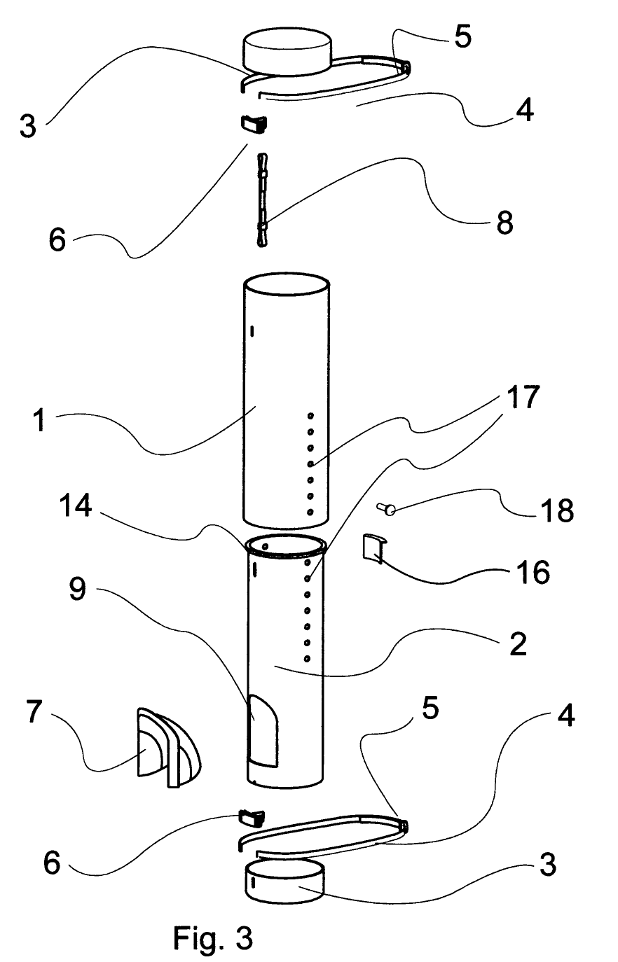

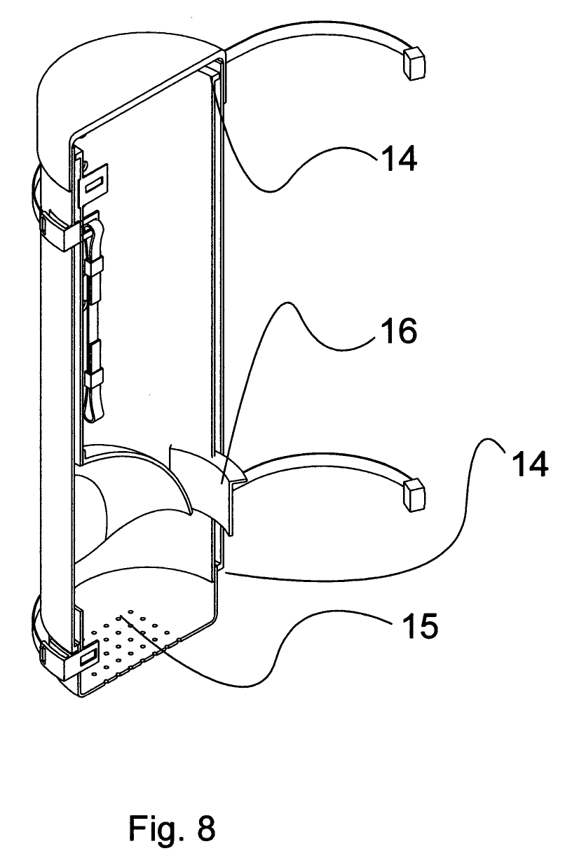

A typical embodiment of the apparatus is illustrated in FIGS. 1 through FIG. 3. A segmented container is comprised of two members, an outer container segment 1 and a inner container segment 2 that adjust open or closed to desired size. In one iteration of the invention, caps 3 close off the container segments 1, 2 with the cap or hatch on top, bottom, or sides of container which allows container to be filled with more feed and protects the dry feed from weather. At least one opening in at least one of the container segments 9 allows for animals to access feed that is stored inside the container that is comprised of segments 1, 2. Brackets or slots or other means 6 of attaching straps or other devices for installing 4 are located on at least one of the container segments 1, 2. A buckle, clip, cinch, or other means of fastening the straps or other devices for installing 5 is located along the straps 4. A formed baffle 7 is located in the interior of at least one of the container segments 1,2. Also, a restricting device 16 is activated to prohibit flow of feed into dispenser. In one iteration this restricting device can be activated to block feed when segment I is slid down over segment 2 and conversely when slid open the restricting device will move to the open position. The restricting device may also be activated manually separate from either container segments. If when segments 1, 2 are opened fully, a lip 14 or other means of mechanical interference prevents the container segments 1,2 from separating, Various means are employed to locate the distance between the container segments 1, 2 In one iteration of the invention an adjustable strap 8 joins a bracket or hook 10 located on the interior wall of the lower container segment 2 to a bracket or hook 6 with a hook or point of attachment on the interior of the upper container segment 1 that could allow for the adjustment of the distance between container segments 1,2, Such adjustment may also be provided by means of a lip, a ridge, a track, a worm gear, or other means for adjusting the size such as holes 17 and pin or other means of interference 18. In the event that water or moisture collects in the animal feed 11, a bottom surface which is flat, contoured, or otherwise shaped to create improved drainage and drying of the feed through single or multiple holes or vents 15 FIG. 8 allow water to drain out of the animal feed 11 so that it may dry.

Operation of the Invention

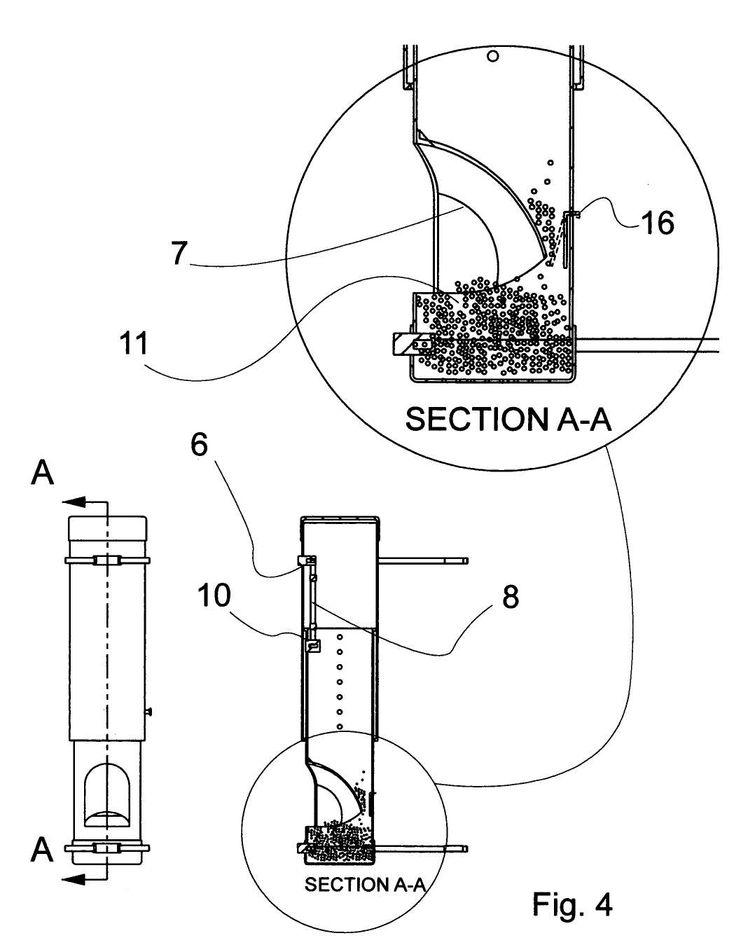

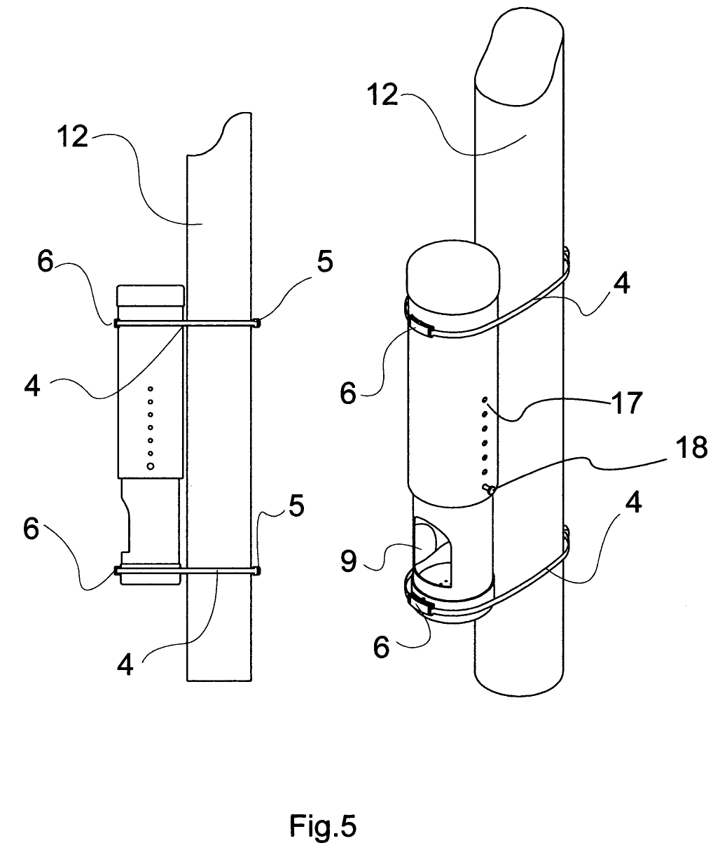

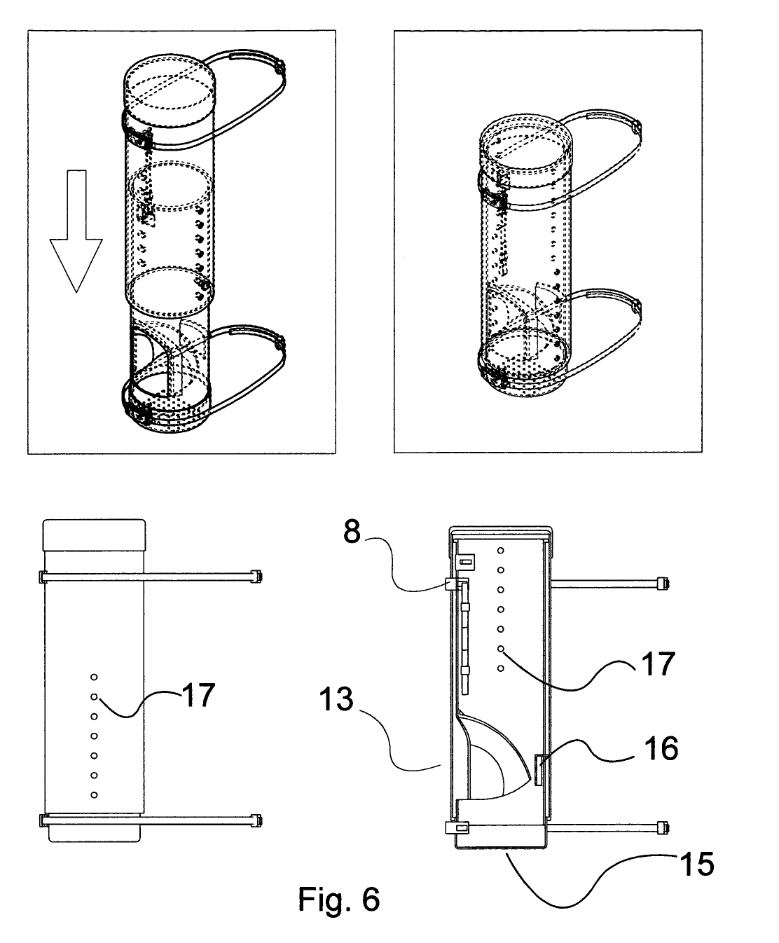

The operation of the apparatus is illustrated in FIGS. 4 through FIG. 6. The baffle 7 provides a means of allowing the feed 11 FIG. 4, to fill the dispenser, or opening 9 in the lower container 1 by gravitational force without overflowing. The baffle 7 allows the feed 11 to continue filling the dispenser until all of the feed contained 1 is used up. The assembled apparatus may be attached to a tree or other structure by means of straps 4 and the strap fastening device 5 FIG. 5. Thus firmly fastening the device prevents tampering with the apparatus by larger animals. When transporting the device the two container segments 1, 2 FIG. 6, nest inside one another so as to simultaneously collapse the apparatus FIG. 6 and also close the opening 9 in one of the container segments 1 or 2 by covering the opening 9 with a portion of the corresponding container segment 13. Also, a restricting device 16 is activated to prohibit flow of feed into dispenser. This device can be activated to block feed when segment 1 is slid down over segment 2 and conversely when slid open the restricting device will move to the open position. An adjustable strap, clip, button, detent or other such mechanism 8 holds the containers together in a closed position FIG. 6, or allows the container segments 1, 2 to spread apart FIG. 4. A lip or form provides interference to keep container segments from accidentally separating 14 when fully extended. The surface beneath the feed dispenser area 9 has holes or vents 15 to let out any water that may gather in the animal feed 11.

1. A collapsible device for containing animal feed

2. An expandable device for dispensing animal feed

3. The device of claim 1 and 2 that may be installed to a tree trunk or other support structure that is convenient and secure

4. The device of claim 1 and 2 including a mechanism for allowing water that may enter the container to drain out and allow the feed to dry again.

5. In combination the device of claim 1 and 2 having a nested multiple part mechanism for collapsing with the outer container having the means to be adjusted as to the distance to be extended from inner container.

6. In combination the device of claim 1 and 2 having a nested multiple part mechanism for collapsing with a means to regulate the dispensing of the feed by a mechanism that can be activated manually or automatically when collapsing.

7. The device of claim 1 and 2 with a mechanism to prevent the segments from separating completely.

8. In combination, a container having a nested multiple part mechanism for collapsing and means for providing containment of animal feed for coupling the collapsing of the device to the said containment of the animal feed

9. The device of claim 2 wherein the device contains the animal feed so as to prevent spillage as in during transport or storage.

10. The device of claim 2 wherein the device collapses so as to provide a compact animal feed dispensing device that is convenient to transport

11. In combination, a container having a nested multiple part mechanism for expanding and a means for providing dispensing of animal feed for coupling the expanding of the device with the said dispensing of the animal feed

12. The device of claim 11 wherein the device dispenses the animal feed in a gravity filled manner

13. The device of claim 11 wherein the device dispenses the animal feed in a gravity filled manner that is self regulating
